(19) United States
(12) Patent Application Publication
(10) Pub. No.: US 2021/0245166 A1
(43) Pub. Date: Aug. 12, 2021

(54) CONE CRUSHER

(71) Applicant: TEREX GB LIMITED, Leicestershire (GB)

(72) Inventor: Ian BOAST, Leicestershire (GB)

(73) Assignee: TEREX GB LIMITED, Leicestershire (GB)

(21) Appl. No.: 17/078,526

(22) Filed: Oct. 23, 2020

(30) Foreign Application Priority Data
Oct. 23, 2019 (GB) 1915353.5

(51) Int. Cl. B02C 2/04

(52) U.S. Cl. CPC B02C 2/045

(57) ABSTRACT

A cone crusher is provided including a frame having a top shell assembly and a bottom shell assembly, and a crusher main shaft slidably supported by the frame. The top shell assembly comprises a spider assembly having a central hub for receiving a top end of the main shat. The bottom shell assembly comprises a hydraulically operated piston assembly configured to raise and/or lower the main shaft with respect to the frame. The top shell assembly further comprises a first crush surface. The crusher further comprises a crusher head assembly supported by the main shaft, the crusher head assembly comprising a second crush surface, wherein the first and second crush surfaces define therebetween a crushing chamber and an opening through which material leaves the crushing chamber when the crusher is in use. The crusher further comprises an adjustment arrangement configured to adjust the position of the first crush surface.

### CROSS-REFERENCE TO RELATED APPLICATIONS

This application claims priority to United Kingdom patent application No. 1915353.5 filed Oct. 23, 2019, the disclosure of which is incorporated in its entirety by reference herein.

### TECHNICAL FIELD

The present disclosure relates to a cone crusher, more particularly, but not exclusively, to a cone crusher for crushing rock material.

### BACKGROUND

Quarried material is often processed, by means of a crushing plant, for the production of aggregate, for example. There are various known forms of crushing plant for the comminution of rock material and the like, one of which is referred to as a cone crusher.

One known type of cone crusher 2 is shown in FIG. 1. The cone crusher 2 is of the type commonly referred to as a “spider crusher” and includes a top shell 6 and a bottom shell 8, which are bolted together along a split line 10 located approximately halfway up the crusher 2.

A crusher head 12 is supported by a shaft 14, which is supported at its upper end by a spider assembly 16 and at its lower end by a hydraulically actuated piston assembly 18. The shaft 14 is slideably supported such that actuation of the piston assembly 18 raises and/or lowers the shaft 14 with respect to the top shell 6. In this way the spacing between crush surfaces 20, 22 can be adjusted. In addition, the position of the crusher head 12 can be adjusted to compensate for wear of the crush surfaces 20, 22.

There are a number of disadvantages with such known spider crushers. For example, the design is very tall which makes it difficult to install in some applications, particularly on mobile equipment.

Additionally, in order to change the wear parts, the top shell and bottom shell must be detached from each other. This can be difficult and time consuming due to the number of large bolts holding the two halves together and the difficulty in separating the two sections. Further, the wear parts can suffer from uneven wear if the feed is distributed unevenly around the chamber. This can cause significant problems.

The present disclosure seeks to overcome or at least mitigate/alleviate one or more problems associated with the prior art.

### SUMMARY

In a first embodiment, a cone crusher is provided comprising a frame having a top shell assembly and a bottom shell assembly, and a crusher main shaft slidably supported by the frame; the top shell assembly comprising a spider assembly having a central hub for receiving a top end of the main shaft of the crusher; the bottom shell assembly comprising a hydraulically operated piston assembly configured to raise and/or lower the main shaft with respect to the frame; the top shell assembly further comprising a first crush surface; the crusher further comprising a crusher head assembly supported by the main shaft, the crusher head assembly comprising a second crush surface, wherein the first and second crush surfaces define therebetween a crushing chamber and an opening through which material leaves the crushing chamber when the crusher is in use; wherein the crusher further comprises an adjustment arrangement configured to adjust the position of the first crush surface.

In this way, the position of the first crush surface (e.g., a concave ring) with respect to the second crush surface (e.g., a mantle) can be adjusted via the adjustment arrangement. The relative position of the first and second crush surfaces can also be adjusted via operation of the piston assembly. Accordingly, two means of adjusting the relative position of the first and second crush surfaces are provided.

In this way, greater control over the relative spacing between the first and second crush surfaces is provided. In exemplary embodiments, this may be advantageous in maintaining even wear of the crush surfaces and/or adjusting the spacing between the surfaces to set the closed side setting (CSS), corresponding to the size of material which can leave the crush chamber via the spacing between the crush surfaces.

Optionally, the crusher head assembly is configured to gyrate about an axis, and the adjustment arrangement is configured to adjust the angular position of the first crush surface with respect to the axis.

In this way, the first crush surface can be rotated with respect to the second crush surface. This enables more even wear of the first crush surface to be achieved. Uneven wear of the first crush surface can effectively create variation in the closed side setting (CSS) around the crushing chamber. This can lead to bearing failures, can limit the minimum achievable CSS, and/or create more variation in the size of the crushed product produced by the crusher. Generating more even wear of the first crush surface mitigates or eliminates some or all of these problems, in addition to increasing the lifespan of the first crush surface. Accordingly, where the first crush surface comprises a replaceable concave ring, the concave ring will need to be replaced less often, reducing cost and downtime.

Optionally, the crusher head assembly is configured to gyrate about the or an axis, and the adjustment arrangement is configured to adjust the axial position of the first crush surface with respect to the axis.

In other words, the first and second crush surfaces can be brought towards or away from each other via the adjustment arrangement. An advantage of this is that the spacing between the crush surfaces can be set to a desired spacing, at least in part, via the adjustment arrangement. Accordingly, a desired closed side setting (CSS) can be specified, at least in part, via the adjustment arrangement.

The piston assembly is configured to raise and lower the main shaft, on which the crusher head assembly is carried. In this way, the crusher head assembly, and hence the second crush surface can be moved towards and away from the first crush surface, thereby adjusting the spacing between the surfaces, and hence the closed side setting (CSS).

It will therefore be apparent that two means for adjusting the spacing between the crush surfaces are provided: the adjustment arrangement and the piston assembly. These may be used independently or in combination.

By providing two means for adjusting the spacing between the crush surfaces, a piston assembly configured to move the main shaft through a reduced length can be provided, as compared to crusher assemblies wherein a piston assembly is the only means of spacing adjustment. Accordingly, cone crushers disclosed herein may be shorter in height as compared to crusher assemblies in which a piston assembly is the only means of spacing adjustment.

Furthermore, since cone crushers disclosed herein are spider crushers having a central hub for receiving a top end of the main shaft of the crusher, the clearance required between the main shaft and the central hub and/or the clearance required between the crusher head assembly and the central hub can be reduced. Thereby providing twice the reduction in height for a given reduction in travel distance of the main shaft.

Further, since the piston assembly is required to move the main shaft through a reduced distance, a more compact piston assembly can be provided, thereby reducing the overall height of the crusher.

Consequently, a more compact spider cone crusher is provided as compared to those known from the prior art.

Optionally, the adjustment arrangement is configured to adjust the axial position of the first crush surface with respect to the axis by up to 500 mm, for example by up to 200 mm, for example by up to 150 mm, e.g., by up to 125 mm.

For example, where the second crush surface is a mantle, for a cone crusher having a mantle diameter of 1200 mm (i.e., the largest diameter), the adjustment arrangement may be configured to adjust the axial position of the first crush surface with respect to the axis by up to 125 mm. It will be appreciated that, in some embodiments, an adjustment arrangement configured to permit a larger or smaller amount of adjustment may be provided.

It will also be appreciated that the adjustment arrangement provided may be configured to adjust the axial position of the first crush surface with respect to the axis by an amount appropriate for the size and/or proportions of the cone crusher.

Optionally, the adjustment arrangement comprises a screw thread coupling between the top shell assembly and the bottom shell assembly.

In this way, a simple means for adjusting both the axial and angular position of the first crush surface with respect to the axis is provided.

Optionally, the screw thread coupling comprises an inner thread arranged on an outer surface of the top shell assembly and an outer thread arranged on an inner surface of the bottom shell assembly.

In some embodiments, the screw thread coupling comprises an inner thread arranged on an outer surface of the bottom shell assembly and an outer thread arrangement arrange on an inner surface of the top shell assembly.

Optionally, the hydraulically operated piston assembly comprises a relief device for releasing the hydraulic pressure in the piston assembly in the event that the pressure exceeds a predetermined threshold.

If an uncrushable object enters the crushing chamber, substantial forces may be generated in the hydraulically operated piston assembly as the crusher head assembly acts to complete its gyratory motion against the uncrushable object. The generation of these forces can cause damage to the crusher. In some cases, this damage can render the crusher inoperative until it is repaired, therefore affecting productivity.

When the forces generated by the uncrushable object in the crushing chamber exceed a predetermined amount, the relief device is actuated. Such actuation releases the hydraulic pressure in the piston assembly, which prevents or limits damage to the crusher.

In this way, the relief device acts to protect the crusher against damage resulting from an uncrushable object entering the crushing chamber.

In exemplary embodiments, the relief device is configured to actuate when a predetermined fore of between 50 and 500 bar is reached, for example between 50 and 300 bar, for example between 60 and 150 bar, for example between 70 and 100 bar.

Optionally, the hydraulically operated piston assembly is arranged to support a lower end of the main shaft and the relief device is configured to release the hydraulic support of from the piston assembly in the event that the pressure exceeds a predetermined threshold.

Optionally, the piston assembly comprises a piston moveable in a cylinder, wherein the piston is configured to raise and/or lower the main shaft with respect to the frame. Optionally, the cylinder has a length of less than 1000 mm, for example less than 500 mm, for example in the range of 200 mm to 450 mm, e.g., 375 mm.

In cone crushers disclosed herein, since the amount of axial movement of the main shaft is reduced, a cylinder of reduced length as compared to an equivalent known spider crusher can be used. It will be appreciated that the cylinder dimensions may be appropriate for the size and/or proportions of the cone crusher.

Optionally, the maximum vertical distance through which the main shaft can be raised and/or lowered is less than 500 mm, for example less than 200 mm.

In other words, the piston assembly is configured such that the piston can be moved through less than 500 mm, for example less than 200 mm. In cone crushers disclosed herein, since two means of adjusting the relative position of the first and second crush surfaces are provided, the vertical distance through which the main shaft can be raised and/or lowered can be less than that of an equivalent known spider crusher.

Optionally, the maximum vertical distance is in the range of 50 mm to 175 mm, for example, 50 mm to 100 mm, e.g., 75 mm.

Optionally, when the main shaft is in a fully retracted position (i.e., away from the spider assembly), a clearance is defined between a top end of the main shaft and an underside of the central hub directly above the top end of the main shaft when the crusher is in use. Optionally, the clearance is less than 500 mm, for example 200 mm, for example in the range of 50 mm to 175 mm, for example, 50 mm to 100 mm, e.g., 75 mm.

It will be appreciated that the clearance required will be the same as the distance through which the main shaft can be raised or lowered. Consequently, since cone crushers disclosed herein can be configured such that the distance through which the main shaft can be raised or lower is reduced, as compared to equivalent known spider crushers, the clearance required is correspondingly reduced.

Accordingly, the reduction in overall height of the cone crushers disclosed herein can be twice the reduction in the distance through which the main shaft can travel. This provides a more compact cone crusher than equivalent known spider crushers.

Optionally, when the main shaft is in a fully retracted position (i.e., away from the spider assembly), a clearance is defined between an uppermost surface of the crusher head and a lower surface of the central hub directly above the uppermost surface of the crusher head. Optionally, the clearance is less than 200 mm, for example in the range of 50 mm to 175 mm, for example, 50 mm to 100 mm, e.g., 75 mm.

Optionally, the second crush surface comprises a mantle having a diameter at its widest point in the range of 750 mm to 3000 mm, e.g., 1200 mm.

In exemplary embodiments, the mantle diameter may be in the range of 1000 mm to 2000 mm, for example 1000 mm to 1500 mm.

Optionally, the second crush surface comprises a mantle and the ratio of the mantle diameter:overall height of the crusher is 1 to less than 3.5, for example, in the range of 1:2 to 1:3, for example 1:2.5.

As used herein, the term “overall height of the crusher” is understood to mean the distance from the top of the spider assembly (corresponding to a clearance under a feeder when in use) to the lowest part of the piston assembly (corresponding to a clearance above a discharge conveyor when in use).

Optionally, the overall height of the crusher is in the range 2500 mm to 5000 mm, for example 2500 mm to 4000 mm, for example 3000 mm to 3100 mm, e.g., 3025 mm.

As previously described, cone crushers disclosed herein may have a reduced height as compared to equivalent known spider crushers.

Optionally, the cone crusher further comprises a locking mechanism which is configured to prevent or inhibit movement of the concave ring.

In this way, once the position of the first crush surface has been adjusted to a desired position, the first crush surface can be locked in this position via the locking mechanism.

Optionally, the adjustment arrangement comprises a screw thread coupling between the top shell assembly and the bottom shell assembly, and the locking mechanism comprises a threaded ring configured to be threaded onto the screw thread coupling such that the threaded ring can be tightened to exert a force against the top shell assembly or bottom shell assembly.

In this way, relative rotation and the top and bottom shell assemblies and/or tilting of the top shell assembly when crushing can be inhibited.

Optionally, the bottom shell assembly comprises a central hub for supporting the or a lower end of the main shaft of the crusher, and an eccentric is mounted on the lower end of the main shaft and configured such that, in use, the eccentric rotates eccentrically about the or an axis causing gyration of the crusher head. Optionally, bearings are provided between the eccentric and the central hub.

In exemplary embodiments, the bearings comprise an uppermost bearing and a lowermost bearing. In cone crushers disclosed herein, since two means of adjusting the relative position of the first and second crush surfaces are provided, the vertical distance through which the main shaft can be raised and/or lowered can be reduced as compared to an equivalent known spider crusher. Consequently, the spacing between the uppermost and lowermost bearings may be reduced as compared to equivalent known spider crushers. Consequently, a more compact and/or simplified bearing assembly can be provided.

Optionally, the crusher head assembly is configured to gyrate about the or an axis, and the adjustment arrangement is configured to adjust the angular position of the first crush surface with respect to the axis by adjusting the angular position of the top shell assembly.

Optionally, the crusher comprises an alignment arrangement configured to restrict an angular position of the top shell assembly to one of one or more predetermined angular positions, when the crusher is in use.

In this way, the angular position of the spider assembly can be controlled.

Optionally, the alignment arrangement comprises a sensor for sensing the angular position of the top shell assembly.

Optionally, the one or more predetermined angular positions are determined based on the relative positions of the spider assembly and a feed source.

In this way, the position of the top shell can be adjusted such that the feed source is aligned with an opening in the spider assembly (i.e., between spider arms of the spider assembly). Accordingly, introduction of material into the crusher is optimized.

### BRIEF DESCRIPTION OF THE DRAWINGS

Embodiments of the disclosure will now be described with reference to the accompanying drawings, in which:

FIG. 1 is a cross section view of a known type of cone crusher commonly referred to as a “spider crusher”;

FIG. 2 is a cross section view of a cone crusher according to an embodiment of the disclosure;

FIG. 3 is a cross section view of a bearing assembly of the embodiment of FIG. 2; and

FIG. 4 is a top down cross section view of the embodiment of FIG. 2, illustrating a locking ring.

### DETAILED DESCRIPTION

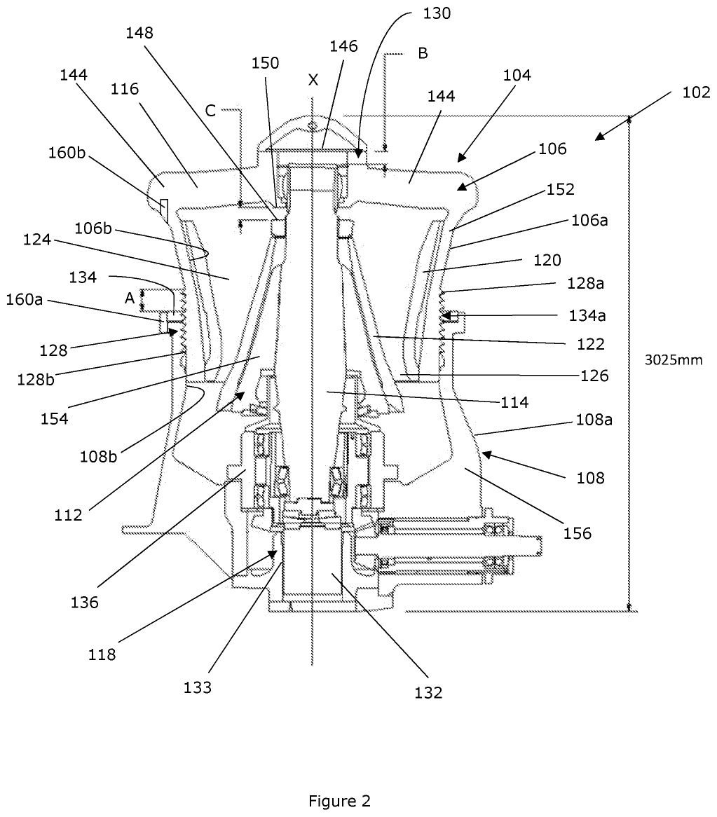

An embodiment of a cone crusher 102 disclosed herein is illustrated in FIG. 2. The crusher 102 includes frame 104 having a top shell assembly 106 and a bottom shell assembly 108. The crusher 102 comprises a main shaft 114 which is slideably supported by the frame 104.

The top shell assembly 106 comprises a top shell frame 152 having an outer surface 106a and an inner surface 106b. Similarly, the bottom shell assembly 108 comprises a bottom shell frame 156 having an outer surface 108a and an inner surface 108b.

The top shell assembly 106 includes a spider assembly 116 having a central hub 130 for receiving a top end of the main shaft 114. The bottom shell assembly 108 is configured to support a lower end of the main shaft 114 and includes a hydraulically actuated piston assembly 118 configured to raise and/or lower the main shaft 114 with respect to the frame 104.

In the illustrated embodiment shown in FIG. 2, the top shell frame 152 and the spider assembly 116 are integrally formed. In some embodiments, the top shell frame and the spider assembly are separate components.

The crusher 102 includes a first crush surface 120 which is provided by the top shell assembly 106. In the illustrated embodiment, the first crush surface 120 is carried by the inner surface 106b of the top shell frame 152. In use, material fed into the crusher 102 is crushed against the first crush surface 120. In the illustrated embodiment, the first crush surface 120 comprises a concave ring. The concave ring 120 is a wearable component and can be removed and replaced when it is worn out.

The crusher 102 also includes a crusher head assembly 112 carried by the main shaft 114. The crusher head assembly 112 comprises a crusher head 154 and a second crush surface 122 against which material fed into the crusher 102 is crushed. In the illustrated embodiment, the second crush surface 122 comprises a mantle carried by the crusher head 154, wherein the mantle 122 is a wearable component that can be removed and replaced when worn.

A crushing chamber 124 is defined between the crush surfaces, i.e., between the concave ring 120 and the mantle 122. The crush surfaces 120, 122 further define an opening 126 through which material leaves the crushing chamber 124 when the crusher 102 is in use.

The crusher 102 includes an adjustment arrangement 128 configured to adjust the position of the first crush surface 120 of the top shell assembly 106 (i.e., the concave ring 120) with respect to the crusher head assembly 116, and hence with respect to the second crush surface 122.

As will be described in further detail below, the crusher head 112 is arranged to gyrate about an axis X, e.g., a longitudinal axis of the crusher 102. The adjustment arrangement 128 is configured to adjust the angular position of the concave ring 120 with respect to the axis X. The adjustment arrangement 128 is also configured to adjust the axial position of the concave ring 120 with respect to the axis X.

In the illustrated embodiment, the adjustment arrangement 128 comprises a screw thread coupling between the top shell assembly 106 and the bottom shell assembly 108. An inner thread 128a is arranged on the outer surface 106a of the top shell frame 152 and an outer thread 128b is arranged on the inner surface 108b of the bottom shell frame 156. In this way, unscrewing the top shell assembly 106 from the bottom shell assembly 108 enables the axial and angular position of the concave ring 120 to be adjusted.

As previously described, the bottom shell assembly 108 includes a hydraulically actuated piston assembly 118 configured to raise and/or lower the main shaft 114 with respect to the frame 104. The piston assembly 118 includes a piston 132 which is moveable in a cylinder 133. The lower end of the main shaft 114 is positioned above the piston 132, such that actuation of the piston 132 results in raising/lowering of the main shaft 114.

The hydraulically actuated piston assembly 118 also includes a relief device (not shown) for releasing the hydraulic pressure in the piston assembly 118 in the event that the pressure exceeds a predetermined threshold. In this way, the piston assembly 118 is configured to release the hydraulic support provided to the main shaft 114 when the pressure exceeds the predetermined threshold.

In exemplary embodiments, the relief device is configured to actuate when a predetermined force of between 50 and 500 bar is reached, for example between 50 and 300 bar, for example between 60 and 150 bar, for example between 70 and 100 bar.

In the illustrated embodiment, the crusher includes a locking mechanism 134 configured to prevent or inhibit movement of the concave ring 120 with respect to the bottom shell assembly 108, e.g., by preventing or inhibiting movement of the top shell frame 152 with respect to the bottom shell assembly 108. In this way, once the desired position of the concave ring 120 has been set, further movement of the concave ring 120 with respect to the bottom shell assembly 108 can be prevented or inhibited.

In the illustrated embodiment, the locking mechanism comprises a locking ring 134 having a threaded inner surface 134a, configured to engage with the outer thread 128a of the top shell frame 152. When the top and bottom shell assemblies 106, 108 are in the desired relative position, the locking ring 134 can be rotated down the outer thread 128a of the top shell frame 152 towards and into contact with the bottom shell frame 156. Further rotation of the locking ring 134 causes the locking ring 134 to exert a force against the bottom shell frame 156, thereby inhibiting rotation between the top and bottom shell assemblies 106, 108. The locking ring 134 can be thought of as a locking nut. In some embodiments, the locking ring 134 may exert a force on the bottom shell frame (to inhibit relative rotation of the shell assemblies) via an intermediate component, such that the locking ring and the bottom shell frame are not in direct contact.

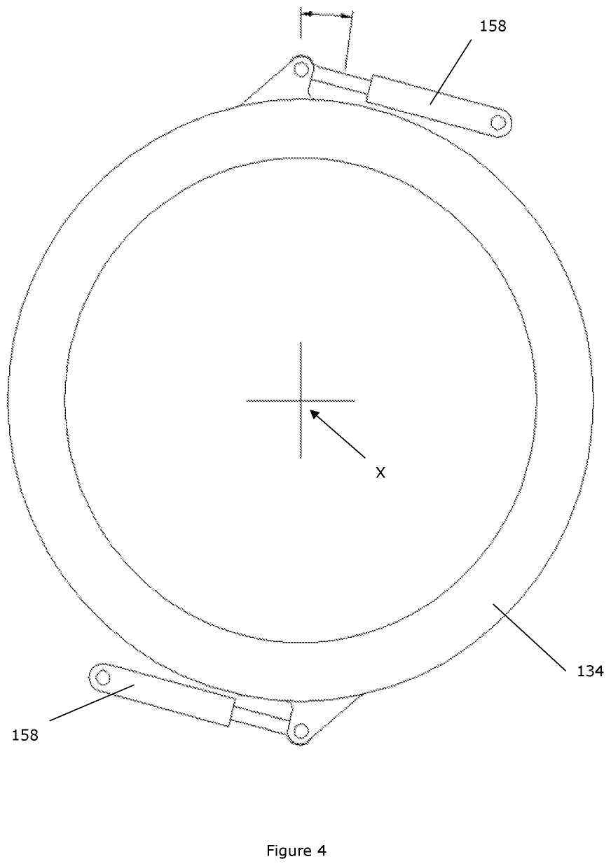

FIG. 4 illustrates a top-down view of the locking ring 134. As illustrated in FIG. 4, a series of hydraulic cylinders 158 are provided for rotating the locking ring 134 and tightening the locking ring 134 to exert force against the bottom shell frame 156. The hydraulic cylinders 158 are not shown on FIG. 2 for clarity. In alternative embodiments, the locking ring 134 can be rotated via a gear drive or any other suitable means.

The locking ring 134 also acts to inhibit tilting of the top shell assembly 106 when the crusher 102 is in use. Since the main shaft 114 is supported by the spider assembly 116 of the top shell assembly 106, rotation of the crusher head assembly 112 can cause forces to be applied to the top shell assembly 106 when the crusher 102 is in use, which can result in tilting of the top shell assembly 106. The locking ring 134 acts to inhibit such tilting.

In alternative embodiments, the locking mechanism may comprise hydraulic jacks exerting a force which acts to push the upper and lower shell assemblies 106, 108 apart (or towards each other) such that the threads 128a,b are forced against each other, inhibiting relative movement of the shells 106, 108. In alternative embodiments, any other suitable locking means can be used.

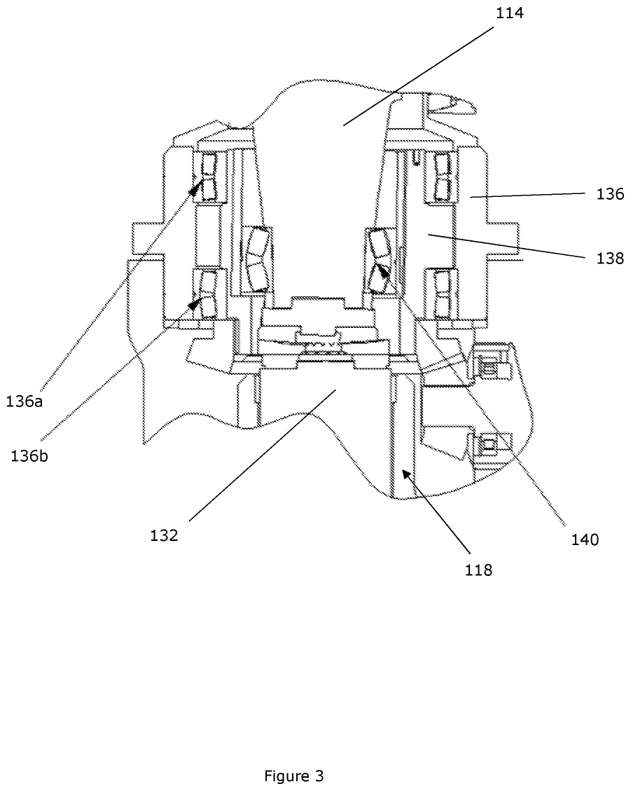

With reference to FIGS. 2 and 3, the bottom shell assembly 108 includes a central hub 136 for supporting a lower end of the main shaft 14. An eccentric 138 is mounted on the lower end of the main shaft 114 and configured such that, in use, the eccentric 138 rotates eccentrically about the axis X, thereby causing gyration of the crusher head assembly 112 about the axis X. In some embodiments, the axis X is coaxial with a longitudinal axis of the crusher 102.

Bearings 136a, b are provided between the eccentric 138 and the central hub 136. These bearings comprise an upper bearing 136a and a lower bearing 136b provided between the eccentric 138 and the central hub 136 to support the main shaft 12. In the illustrated embodiment, bearings 136a, b are roller bearings. In some embodiments, plain bearing (i.e., bushings) are used. In some embodiments, a single bearing is provided.

Additional bearing 140 is provided between the main shaft 114 and the eccentric 128.

It will be appreciated by those skilled in the art that the spider assembly 116 comprises a series of spider arms 144 extending from the central hub 130 to an outer diameter of the spider assembly 116. Gaps (not shown) are provided between the spider arms 144 and material to be crushed can be fed into the crush chamber 124 via one or more of these gaps.

In some embodiments, the crusher 102 includes an alignment arrangement 160a, b configured to restrict the angular position of the top shell assembly 106, and hence the spider assembly 116, to one of one or more predetermined angular positions, when the crusher 102 is in use.

In some embodiments, the alignment arrangement comprises a sensor 160a for sensing the angular position of the top shell assembly 106. The sensor 160a may be mounted at any suitable location on the bottom shell assembly 108. The sensor 160a may be configured to detect a feature of the top shell assembly 108 itself, and from this determine the angular position of the top shell assembly 106. Alternatively, as is shown in FIG. 2, the top shell assembly 106 may comprise a target 160b configured to be detectable by the sensor 160a. Any suitable sensor and target 160a, b may be used.

The one or more predetermined angular positions may be determined based on the relative positions of the spider assembly 116 and a feed source (not shown). For example, the top shell assembly 106 may be positioned such that the or each feed source is aligned with one or more of the gaps between the spider arms 144 of the spider assembly 116.

In use, material to be crushed is introduced into the crushing chamber 124. As the crusher head assembly 112 gyrates about the longitudinal axis X, the mantle 122 is caused to gyrate relative to the concave ring 120. In this way, material in the crushing chamber 124 is crushed against the mantle 122 and the concave ring 120 to create smaller pieces of material. When the pieces of material are small enough, they fall through the opening 126 between the crush surfaces 120, 122, leaving the crushing chamber 124.

The spacing between the mantle 122 and concave ring 120 sets the size of material that is produced by the crusher 102. The size of this spacing (i.e., opening 126) is often referred to as the “Closed Side Setting (CSS)”.

With reference to FIG. 2, the spacing between the mantle 122 and the concave ring 120 can be adjusted by movement of the piston 132 in the cylinder 133. As the piston 132 is moved upwards, the main shaft 114, and the crusher head assembly 112 carried by the main shaft 114, are consequently also moved upwards due to the action of the piston 132. In this way, the mantle 122 and concave ring 120 are brought towards each other, thereby reducing the spacing therebetween.

Advantageously, adjustment of the spacing between the mantle 122 and the concave ring 120 by movement of the piston 132 can be carried out during crushing.

As can be seen in FIG. 2, the spacing between the mantle 122 and the concave ring 120 can also be adjusted via the adjustment mechanism 128. By rotating the top shell assembly 106 with respect to the bottom shell assembly 108, the top shell assembly 106 can be screwed towards or away from the bottom shell assembly 108. In this way, both the axial and angular position of the top shell assembly 106 with respect to the crusher head assembly 112 can be adjusted.

By making this adjustment, the spacing between the concave ring 120, which is carried by the top shell frame 152, and the mantle 122, which is carried by the crusher head 154, can be adjusted. This adjustment can be used to determine the size of material that is produced by the crusher 102 by setting the closed side setting. In some cases, adjustment of the position of the top shell assembly 106 with respect to the bottom shell assembly 108 can be made to maintain a predetermined closed side setting to compensate for wear of the mantle 122 and/or the concave ring 120.

In exemplary embodiments, the concave ring 120 is carried by the top shell frame 152 such that the concave ring 120 is fixed for movement with the top frame assembly 106.

In the illustrated embodiment, the adjustment arrangement 128 is configured to adjust the axial position of the concave ring 120 with respect to the longitudinal axis X by distance “A”, which can be up to 125 mm. In alternative embodiments the adjustment arrangement may be configured to adjust the axial position of the concave ring by up to 500 mm, for example by up to 200 mm, for example by up to 150 mm. It will be appreciated that an adjustment arrangement configured to adjust the axial position of the concave ring by any desired amount can be provided.

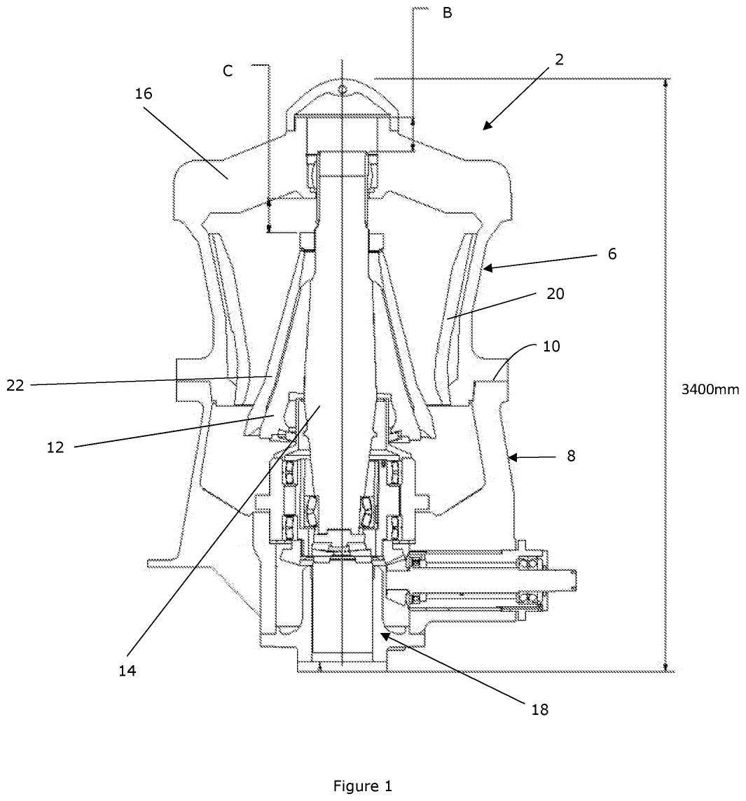

Since the spacing between the crush surfaces 120, 122 can be set or maintained, at least in part, by positioning the concave ring 120 via the adjustment mechanism 128, the extent to which the crusher head assembly 112 needs to travel axially can be reduced, whilst still achieving the same degree of control of the spacing between the crush surfaces 120, 122. In other words, since the adjustment arrangement 128 is configured to move the concave ring 120 towards and away from the mantle 122, the extent to which the mantle 122 needs to be moveable towards and away from the concave ring 120 can be reduced, whilst still achieving the same degree of control of the closed side setting as for a corresponding crusher of the type shown in FIG. 1.

Consequently, the distance through which the piston 132 needs to be moveable can be less in crushers disclosed herein as compared to a corresponding crusher of the type shown in FIG. 1.

In the illustrated embodiment, the distance through which the piston 132 is configured to move is up to 75 mm. By comparison, for an equivalent crusher of the type shown in FIG. 1, the piston must be able to move by up to 200 mm in order to achieve the same degree of control of the closed side setting.

Accordingly, the cylinder 133 can be of a shorter length as compared to an equivalent crusher of the type shown in FIG. 1. In the illustrated embodiment in FIG. 2, the cylinder 133 has an axial length of 375 mm. By comparison, a corresponding crusher of the type shown in FIG. 1 has a cylinder having an axial length of 500 mm.

These differences in the piston assembly 118 of the embodiment illustrated in FIG. 2 as compared to the piston assembly 18 of a corresponding crusher of the type shown in FIG. 1 leads to a reduction in the overall height of the crusher of 250 mm. In the illustrated embodiment, this reduction in overall height is achievable for a cone crusher having a mantle diameter of 1200 mm. It will be appreciated that different height savings will be achievable for different crusher configurations and sizes. However, for any size of crusher, cone crushers disclosed herein will have a reduced height as compared to an equivalent cone crusher of the type illustrated in FIG. 1.

Additionally, since the maximum travel distance of the main shaft 114 is reduced, a reduced clearance between an underside 146 of the central hub 130 of the spider assembly 116 and a top end of the main shaft 114 is required. This is illustrated by clearance “B” in FIG. 2. The clearance required will correspond to the maximum movement of the piston and so for the embodiment of FIG. 2 will be 75 mm. The corresponding clearance for an equivalent crusher 2 of the type shown in FIG. 1 is 200 mm (i.e., the maximum travel distance of the shaft 14).

Similarly, since the maximum travel distance of the main shaft 114 is reduced, a clearance between an uppermost surface of the crusher head 148 and a lowermost surface 150 of the central hub 130 and/or spider assembly 116 can also be reduced. In the illustrated embodiment in FIG. 2, this is shown as clearance “C” and will also be 75 mm. The corresponding clearance for an equivalent crusher of the type shown in FIG. 1 is 200 mm (i.e., the maximum travel distance of the shaft 14).

It will therefore be appreciated that a further reduction in the height of the crusher 102 is achieved. Accordingly, the total reduction in height of the crusher 102 as compared to an equivalent crusher of the type shown in FIG. 1 is 375 mm.

From the above it will be appreciated that, for a given reduction in the maximum distance through which the piston 132/main shaft 114 can travel, a reduction in overall height of the crusher 102 equating to twice the reduction in the amount of piston travel is achievable. Further, an additional reduction in height is achievable where there is a reduction in axial length of the cylinder 133.

The overall height of the crusher illustrated in FIG. 2 is 3025 mm, whereas a corresponding crusher of the type shown in FIG. 1 is 3400 mm. Accordingly, an 11% reduction in the total height of the crusher is achievable. In some embodiments, the reduction in the total height of the crusher is in the range 5% to 25%, for example 7% to 15%. It will be appreciated that the illustrations in FIGS. 1 and 2 are not to scale.

In the illustrated embodiment in FIG. 2, the ratio of the mantle diameter (at its largest diameter) to overall height of the crusher is 1:2.5. By way of comparison, an equivalent crusher of the type shown in FIG. 1 has a mantle diameter to overall machine height ratio of 1:3.5. In some embodiments of crushers disclosed herein, this ratio is 1 to less than 3.5, for example, in the range of 1:2 to 1:3, for example 1:2.5. In the illustrated embodiments the mantle diameter is 1200 mm.

Again, it will be appreciated that the height savings achievable by crushers disclosed herein depend on the configuration and size of the crusher. However, for any size of crusher, cone crushers disclosed herein can have a reduced height as compared to an equivalent cone crusher of the type illustrated in FIG. 1.

Further, adjustment of the position of the concave ring 120 via the adjustment arrangement 128 has the benefit of enabling adjustment of the angular position of the concave ring 120 with respect to the axis X to be achieved. This enables control of the wear of the concave ring 120 to avoid uneven wear, and so increases the life span of the concave ring 120.

With reference to FIG. 3, since the main shaft 144 of the illustrated embodiment is moveable through a reduced distance, the upper and lower bearings 136a, 136b, can be spaced closer together as compared to the corresponding arrangement of FIG. 1. This allows for a reduction in component height, which may translate to a reduction in machine height. In embodiments comprising a single bearing between the eccentric 138 and the central hub 136, a reduction in the height of the bearing may also be achieved.

Although the invention has been described in relation to one or more embodiments, it will be appreciated that various changes or modifications can be made without departing from the scope of the disclosure as described in the appended claims. For example, it will be appreciated that cone crushers disclosed herein may have any suitable size or dimensions.

What is claimed is:

1. A cone crusher comprising a frame having a top shell assembly and a bottom shell assembly, and a crusher main shaft slidably supported by the frame; the top shell assembly comprising a spider assembly having a central hub for receiving a top end of the main shaft of the crusher; the bottom shell assembly comprising a hydraulically operated piston assembly configured to raise and/or lower the main shaft with respect to the frame; the top shell assembly further comprising a first crush surface; the crusher further comprising a crusher head assembly supported by the main shaft, the crusher head assembly comprising a second crush surface, wherein the first and second crush surfaces define therebetween a crushing chamber and an opening through which material leaves the crushing chamber when the crusher is in use; wherein the crusher further comprises an adjustment arrangement configured to adjust position of the first crush surface.

2. The cone crusher according to claim 1, wherein the crusher head assembly is configured to gyrate about an axis, and the adjustment arrangement is configured to adjust angular position of the first crush surface with respect to the axis.

3. The cone crusher according to claim 1, wherein the crusher head assembly is configured to gyrate about an axis, and the adjustment arrangement is configured to adjust axial position of the first crush surface with respect to the axis.

4. The cone crusher according to claim 3, wherein the adjustment arrangement is configured to adjust the axial position of the first crush surface with respect to the axis by up to 500 mm.

5. The cone crusher according to claim 1, wherein the adjustment arrangement comprises a screw thread coupling between the top shell assembly and the bottom shell assembly.

6. The cone crusher according to claim 5, wherein the screw thread coupling comprises an inner thread arranged on an outer surface of the top shell assembly and an outer thread arranged on an inner surface of the bottom shell assembly.

7. The cone crusher according to claim 1, wherein the hydraulically operated piston assembly comprises a relief device for releasing hydraulic pressure in the piston assembly in the event that the pressure exceeds a predetermined threshold.

8. The cone crusher according to claim 1, wherein the piston assembly comprises a piston moveable in a cylinder, wherein the piston is configured to raise and/or lower the main shaft with respect to the frame, and wherein the cylinder has a length of less than 1000 mm.

9. The cone crusher according to claim 1, wherein maximum vertical distance through which the main shaft can be raised and/or lowered is less than 500 mm.

10. The cone crusher according to claim 1, wherein, when the main shaft is in a fully retracted position (i.e., away from the spider assembly), a clearance is defined between a top end of the main shaft and an underside of the central hub directly above the top end of the main shaft when the crusher is in use, the clearance being less than 500 mm.

11. The cone crusher according to claim 1, wherein, when the main shaft is in a fully retracted position (i.e., away from the spider assembly), a clearance is defined between an uppermost surface of the crusher head and a lower surface of the central hub directly above the uppermost surface of the crusher head, the clearance being less than 200 mm.

12. The cone crusher according to claim 1, wherein the second crush surface comprises a mantle having a diameter at its widest point in the range of 750 mm to 3000 mm.

13. The cone crusher according to claim 1, wherein the second crush surface comprises a mantle and the ratio of the mantle diameter to overall height of the crusher is 1 to less than 3.5.

14. The cone crusher according to claim 1, wherein overall height of the crusher is in the range 2500 mm to 5000 mm.

15. The cone crusher according to claim 1, further comprising a locking mechanism which is configured to prevent or inhibit movement of the first crush surface.

16. The cone crusher according to claim 15, wherein the adjustment arrangement comprises a screw thread coupling between the top shell assembly and the bottom shell assembly, and wherein the locking mechanism comprises a threaded ring configured to be threaded onto the screw thread coupling such that the threaded ring can be tightened to exert a force against the top shell assembly or bottom shell assembly.

17. The cone crusher according to claim 1, wherein the bottom shell assembly comprises a central hub for supporting a lower end of the main shaft of the crusher, wherein an eccentric is mounted on the lower end of the main shaft and configured such that, in use, the eccentric rotates eccentrically about an axis causing gyration of the crusher head, and wherein bearings are provided between the eccentric and the central hub.

18. The cone crusher according to claim 1, wherein the crusher head assembly is configured to gyrate about an axis, and the adjustment arrangement is configured to adjust angular position of the first crush surface with respect to the axis by adjusting angular position of the top shell assembly.

19. The cone crusher according to claim 18, wherein the crusher comprises an alignment arrangement configured to restrict an angular position of the top shell assembly to one of one or more predetermined angular positions, when the crusher is in use.

20. The cone crusher according to claim 19, wherein the one or more predetermined angular positions are determined based on relative positions of the spider assembly and a feed source.
